(19) United States
(12) Patent Application Publication
(10) Pub. No.: US 2023/0249106 A1
(43) Pub. Date: Aug. 10, 2023

(54) FILTER APPARATUS

(71) Applicant: ILLINOIS TOOL WORKS INC., Glenview, IL (US)

(72) Inventors: Isabelle CHANTOME, Sannois (FR); Sylvain MARTINEAU, Chamant (FR); Etienne PIOT, Vineuil Saint Firmin (FR)

(21) Appl. No.: 18/014,688

(22) PCT Filed: Jun. 24, 2021
(86) PCT No.: PCT/US2021/038860

§ 371 Date: Jan. 5, 2023

(30) Foreign Application Priority Data
Jul. 7, 2020 (EP) 20184545.0
May 6, 2021 (EP) 21172431.5

(51) Int. Cl. B01D 29/23; B01D 35/02; B01D 35/30; H01M 8/04044

(52) U.S. Cl. CPC B01D 29/23; B01D 35/02; B01D 35/30; H01M 8/04044; B01D 2201/02

(57) ABSTRACT

An inline filter apparatus includes a housing having an inlet spaced apart from an outlet such that the housing is configured to allow liquid to flow therethrough. A filter portion includes a filter material coupled to a frame. The filter portion includes an open end corresponding to the inlet configured such that liquid flows into the filter portion and a closed end, and the frame tapers from the open end to the closed end.

The present invention relates to a filter apparatus. In particular, but not exclusively, certain examples of the present invention relates to a filter apparatus for a coolant system of a fuel cell for powering a vehicle.

### BACKGROUND

A fuel cell vehicle (FCV) uses a stack of fuel cells to power an electric motor. In each one of these cells energy from a chemical reaction between hydrogen and airborne oxygen is converted into electricity. One of the products of this reaction is heat. To prevent overheating a coolant liquid (for example water) may be passed through the fuel cell stack in conduits to absorb the heat produced. The conduits weave throughout the fuel stack. These conduits traditionally have a small diameter to maximise the surface area available for cooling. The coolant liquid is susceptible to collecting particulates throughout the lifetime of the fuel cell. These particulates can then build up in the small conduits of the fuel cell causing reduced coolant flow and in some cases blockages. This can result in an overheating of the fuel cells and reduced engine efficiency.

It is known to provide a filter apparatus for use in the coolant system to collect the particulates. It is also known to provide such a filter as an inline filter. As used herein the term “inline filter” is intended to mean a filter apparatus, which, in use, can be coupled to conduits transporting a liquid to filter that liquid. For example, the housing of the filter apparatus may form part of the piping suppling coolant to the fuel cells. Such inline filter apparatus which can be used in a coolant system of a fuel cell for powering a vehicle. One drawback of existing inline filters used in fuel cell vehicles is that pressure drop at an end of such filter causes turbulences which negatively impact the functioning of the filter.

The manufacturing of such inline filters involves several steps and is therefore costly and complex.

It would be useful to provide an inline filter apparatus which is designed in way which reduces such turbulences

It would also be useful to provide an inline filter apparatus which is easy to manufacture and assemble.

### SUMMARY OF THE INVENTION

According to a first aspect of the present invention there is provided an inline filter apparatus, the inline filter apparatus comprising: a housing having an inlet spaced apart from an outlet such that the housing is configured to allow liquid to flow therethrough; and a filter portion comprising a filter material coupled to a frame; wherein the filter portion comprises an open end corresponding to the inlet configured such that liquid flows into the filter portion and a closed end; and wherein the frame tapers from the open end to the closed end.

This reduces or in some cases almost eliminates the localised pressure drop at the distal end of the filter apparatus. Turbulence within the filter portion is reduced and liquid flow through the in line filter apparatus is substantially laminar

According to an embodiment of the invention, the filter apparatus comprises a first connection portion at a first end and acting as the inlet and a second connection portion at a second end and acting as the outlet with the housing therebetween, and wherein the frame tapers in a direction away from the first connection portion.

According to an aspect of the invention, the frame tapers linearly from the open end to the closed end.

According to an embodiment of the invention, the frame has a truncated pyramidal shape.

According to an embodiment of the invention, the frame has a frustoconical shape.

According to an aspect of the invention, the frame tapers from the open end to rounded end.

According to an embodiment of the invention, the frame tapers from the open end to a pointed end.

According to an embodiment of the invention, the end of the frame tapers to a seam.

By tapering the frame from the open end to the closed end, there is a reduced pressure drop in the liquid beyond the distal end of the filter portion. This is because the seam interrupts the flow of the coolant liquid significantly less than a truncated end to the filter portion. This reduces or in some cases almost eliminates the localised pressure drop at the distal end of the filter apparatus. Turbulence within the filter portion is reduced and liquid flow through the in line filter apparatus is substantially laminar.

According to an embodiment of the invention, the end of the filter portion distal to the first connection portion is planar.

According to an embodiment of the invention, the filter portion has a duckbill like shape.

According to an embodiment of the invention, the housing comprises an opening at a first end and the second connection portion at a second end; and the opening is configured to engage with the first connection portion such that the filter portion is enclosed within the housing.

According to an embodiment of the invention, the first connection portion is integral with a frame of the filter portion

The invention also relates to a coolant system for a fuel cell for powering a vehicle, the coolant system comprising an inline filter apparatus according to the invention.

According to a second aspect of the present invention there is provided an inline filter apparatus for a coolant system of a fuel cell for powering a vehicle, the filter apparatus comprising: a first connection portion for connection with a pipe of the fuel cell; and a filter portion comprising a frame and a filter material coupled to the frame; wherein the connection portion is integral with the frame of the filter portion.

According to an aspect of the invention, the filter portion is tapered in a direction away from the first connection portion.

According to an aspect of the invention, the end of the filter portion distal to the first connection portion tapers to a seam.

According to an aspect of the invention, wherein the filter apparatus further comprises a housing, the housing comprising an opening at a first end and a second connection portion at a second end; and
wherein the opening is configured to engage with the first connection portion such that the filter portion is enclosed within the housing.

### BRIEF DESCRIPTION OF THE DRAWINGS

Embodiments of the invention are further described hereinafter with reference to the accompanying drawings, in which:

FIG. 1A is a perspective view of an example of an inline filter apparatus according to the invention;

FIG. 1B is a partially cut away view of the filter apparatus of FIG. 1A showing a frame of a filter portion;

FIG. 2 illustrates the filter portion of FIG. 1B including a filter material coupled to the frame; and

FIG. 3 illustrates an alternative example of a filter portion.

In the drawings like reference numerals refer to like parts.

### DETAILED DESCRIPTION

The present invention relates to an inline filter apparatus which may be used in a coolant system for a fuel cell for powering a vehicle. Some examples of the invention may comprise a closed loop coolant circuit in place of the coolant system. As used herein the term “inline filter” is intended to mean a filter apparatus, which, in use, can be coupled to conduits transporting a liquid to filter that liquid. For example, the housing of the filter apparatus may form part of the piping suppling coolant to the fuel cells.

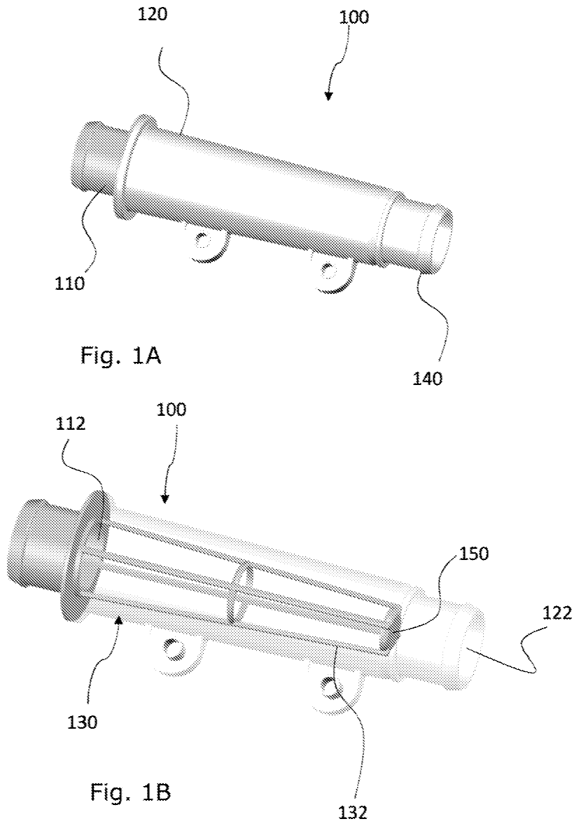

Referring now to FIG. 1A and FIG. 1B an example of an inline filter apparatus 100 is shown, with FIG. 1B being cut away to reveal internal detail. The filter apparatus 100 includes a first connection portion 110, a housing 120 and a filter portion 130. The filter portion 130 is shown in-situ in the housing 120 in FIG. 1B. The housing 120 may be of similar or equal diameter to that of the conduits of the engine, thus avoiding a pressure alteration in the coolant liquid.

In this example, the housing 120 is a longitudinal conduit including a second connection portion 140 at one end. The second connection portion 140 may be integral with the housing 120. The filter apparatus 100 thus has a first connection portion 110 at a first end and a second connection portion 140 at an opposed second end, with the housing 120 therebetween. Each of the connection portions 110, 140 have an aperture 112, 122 for allowing liquid to flow into or out of the housing 120. When assembled, for instance in a coolant system of a fuel cell, the first connection portion 110 may connect to a pipe or conduit supplying coolant liquid and thus act as the inlet to the filter apparatus 100.

Thus, the filter apparatus comprises the first connection portion 110 at a first end and acting as the inlet and the second connection portion 140 at a second end and acting as the outlet with the housing 120 therebetween.

The housing 120 may comprise an opening at a first end and the second connection portion 140 at a second end and the opening may be configured to engage with the first connection portion 110 such that the filter portion is enclosed within the housing.

The housing 120 couples to the first connection portion 110 at the inlet end. This coupling may be releasable in the sense that the first connection portion 110 can be removed from the housing for maintenance. The second connection portion 140 at the second end of the housing 120 can be connected to an inlet of further pipe or conduit, thus acting as the outlet for the filter apparatus 100. The housing 120 therefore forms the connecting pipe between two conduits with the filter portion 130 enclosed within. The filter portion 130 is in this way in line with the coolant liquid which passes through the conduits. As such, the interruption of the flow of the coolant liquid is reduced.

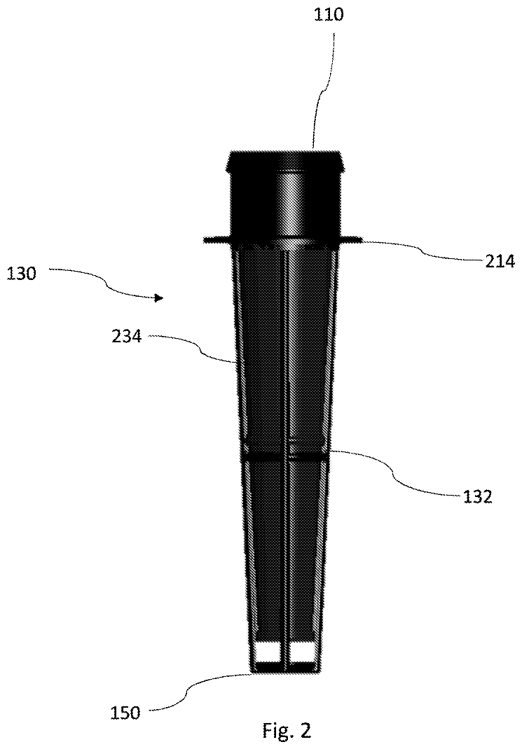

As shown in FIG. 1B the filter portion 130 has a frame 132. The frame 132 extends within the housing from the first connection portion 110 towards the further connection portion 140. This frame 132 forms a skeleton for the filter portion 130, to which a filter material (shown in FIG. 2) can be coupled.

The first connection portion 110 is integrally formed with the frame 132 of the filter portion 130. Therefore, the first connection portion 110 is integral with a frame 132 of the filter portion 130.

That is, the first connection portion 110 and the filter portion 130 are one unbroken piece. This piece may be formed by injection moulding for example. The first connection portion 110 can be integral with the frame 132 of filter portion 130 in this way if the diameter of the first connection portion is similar to the diameter of the inlet to the filter portion 130. Particularly, the first connection portion 110 can be integral with the frame 132 of filter portion 130 in this way if the inner diameter of the filter portion 130 is equal to smaller than the inner diameter of first connection portion 110.

The filter portion 130 has an open end, which is coupled to the first connection portion 110 and allows for the entry of coolant liquid into the filter apparatus 100. The opposing end of the filter portion 130 is a smaller closed end. The pressure of liquid moving into the filter portion 130 pushes the liquid out of the filter portion 130 through the filter material. As discussed above, the frame 132 extends away from the first connection portion 110 into the housing 120 towards the second connection portion 140 of the housing 120. The end of the frame 132 which is adjacent to the first connection portion 110 has a larger diameter than the opposing distal end 150. The frame 132 tapers away from the first connection portion 110 to the distal end 150. The frame 132 tapers in a direction away from the first connection portion 110.

According to an example according to the invention, the frame 132 tapers linearly from the open end to the closed end. In this way, the volume of the filter potion 130 reduces from the inlet of the filter apparatus 100.

According to an aspect of the invention, the frame 132 is frustoconical (or the frame 132 has a frustoconical shape). Other frame examples may have various tapering shapes such as a truncated pyramidal shape.

In particular, the cross sectional shape of mm frame may vary. The filter portion 130 may be between 100 mm and 150 millimetres in length. Aptly the filter portion 130 is approximately 125 mm in length. The connection portion and open end of the filter portion 130 may have a diameter of between 20 mm and 40 mm. Aptly the diameter is approximately 30 mm. The dimeter of the distal end 150 of the filter portion 130 may be between 15 millimetres and 25 mm. Aptly the dimeter is approximately 19 mm. The taper of the filter portion 130 may therefore be approximately 3 degrees.

Referring now to FIG. 2 the filter material 234 is shown coupled to the frame 132. Together the frame 132 and the filter material 234 form the filter portion 130. The filter material 234 may be a mesh or permeable sheeting capable of retaining particulates while allowing coolant liquid therethrough. The filter material 234 may be over moulded onto the frame 132. The filter material may be a meshed polyamide or polyester or other membrane material for example. Suitably, the filter material can be a square mesh with membrane pore size selected according to the required filtration parameters. The frame may, for instance be polyamide, polyoxymethylene, polyester, polyethylene or any other suitable material known to the skilled person.

The frame 132 of the filter portion 130 encloses the aperture 112 of the first connection portion 110. Therefore, any liquid passing through the first connection portion 110 is directed into the filter portion 130. As such, the coolant liquid passes through the filter material 234 thereby filtering the coolant liquid to remove impurities.

The first connection portion 110 may be a substantially cylindrical member suitable to engage with the inner walls of a pipe. In this example, the first connection portion comprises a flange 214, which in use abuts the periphery of the housing 120 to maintain the filter portion 130 in position within the housing 120. The flange 214 protrudes from the outer surface of the housing 120 between the frame 132 and the first connection portion 110. As such, the flange 214 may provide additional sealing between the housing 120 and first connection portion 110 as the housing 120 sits flush against the flange 214 such that the coolant liquid is directed through aperture 112 of the first connection portion 110 and into the filter portion 130.

In this example, the distal end portion 150 (which is opposite the connection portion end) is a planar end portion: that is, the flat portion of the frusto-conical shape. This distal end portion 150 is formed of the frame material. That is, the distal end portion 150 is impermeable to the coolant liquid. This is because using the filter material 234 at the distal end 150 requires a more complex manufacturing process to create a disc end shape. In addition, there would be a build-up in particles at this end over the lifetime of the filter apparatus 100, which would then become impermeable to liquid anyway. This flat portion at the distal end 150 can cause a slight localised drop in pressure in the filter apparatus just beyond the end of the filter portion 130. In some examples the distal end 150 may not be completely flat and may include a small indentation towards the first connection portion 110 (not shown).

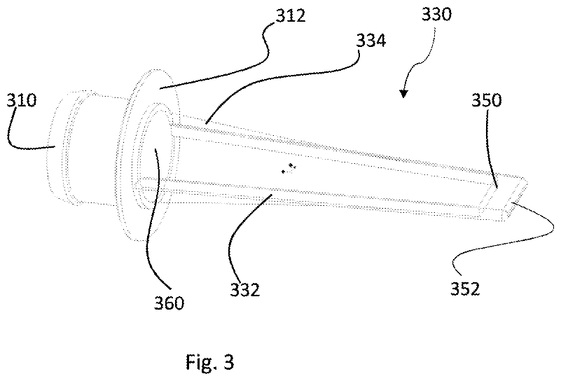

FIG. 3 shows an example of a filter portion 330 with an alternate shape. The first connection portion 310 and housing (not shown) are the same as those described above and thus will not be described again for brevity.

In this example the frame 332 of the filter portion 330 tapers from the proximal end 360 (which is an open end) which is adjacent to (and integral with) the first connection portion 310 to a distal end 350. According to another example of the present invention, the frame 332 of the filter portion 330 is not integral with the first connection portion 310.

At the distal end 350 of the filter portion 330 the frame 332 forms a seam 352. Thus the frame 332 tapers to the seam 352. This seam 352 results in the filter portion 330 having a distal end 350 which is a flattened shape. The filter portion 330 therefore has a duckbill-like shape. That is, the proximal end 360 of the filter portion 330 has a cylindrical shape which tapers to a flat linear shape at the distal end 350. The diameter of the filter portion 330 at the proximal end 360 is at least equal to (and in some cases longer than) the length of the seam 352 at the distal end 350. The proximal end 360 of the filter portion 130 may have a diameter of between 20 mm and 40 mm. Aptly the dimeter is approximately 30 mm. The end of the filter portion distal to the first connection portion 110 tapers to the seam 352.

By tapering to a seam at the distal end 350 of the filter portion 330 there is a reduced pressure drop in the liquid beyond the distal end 350 of the filter portion 330. This is because the seam 352 interrupts the flow of the coolant liquid significantly less than a truncated end to the filter portion 330. This reduces or in some cases almost eliminates the localised pressure drop at the distal end of the filter apparatus. Turbulence within the filter portion 330 is reduced and liquid flow through the in line filter apparatus is substantially laminar.

Other alternative shapes for the distal end of the filter apparatus are also envisaged. For example, the frame 132 of the filter portion may taper to a rounded end or to a pointed end, for example.

With the above-described arrangement an inline filter apparatus which is suitable to be used in a coolant system of a fuel cell for an engine can be provided in two pieces compared to the usual three (the connection portion and filter portion traditionally come separated) this allows for quicker and cheaper manufacturing. Additionally, assembly time may be reduced.

By forming the connection portion and the frame portion integrally the connection portion holds the frame in place in the housing creating a more stable filter apparatus than previously known configurations.

It will be clear to a person skilled in the art that features described in relation to any of the embodiments described above can be applicable interchangeably between the different embodiments. The embodiments described above are examples to illustrate various features of the invention.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. An inline filter apparatus, the inline filter apparatus comprising:
a housing having an inlet spaced apart from an outlet such that the housing is configured to allow liquid to flow therethrough; and
a filter portion comprising a filter material coupled to a frame;
wherein the filter portion comprises an open end corresponding to the inlet configured such that liquid flows into the filter portion and a closed end; and
wherein the frame tapers from the open end to the closed end.

2. An inline filter apparatus as claimed in claim 1, wherein the filter apparatus comprises a first connection portion at a first end and acting as the inlet and a second connection portion at a second end and acting as the outlet with the housing therebetween, and wherein the frame tapers in a direction away from the first connection portion.

3. An inline filter apparatus as claimed in claim 1, wherein the frame tapers linearly from the open end to the closed end.

4. An inline filter apparatus as claimed in claim 1, wherein the frame has a truncated pyramidal shape.

5. An inline filter apparatus as claimed in claim 1, wherein the frame has a frustoconical shape.

6. An inline filter apparatus as claimed in claim 1, wherein the frame tapers from the open end to rounded end.

7. An inline filter apparatus as claimed in claim 1, wherein the frame tapers from the open end to a pointed end.

8. An inline filter apparatus as claimed in claim 1, wherein the end of the frame tapers to a seam.

9. An inline filter apparatus as claimed in claim 8, wherein the end of the filter portion distal to the first connection portion is planar.

10. An inline filter apparatus as claimed in claim 1, wherein the filter portion has a duckbill like shape.

11. A inline filter apparatus as claimed in claim 2, wherein the housing comprises an opening at a first end and the second connection portion at a second end; and
wherein the opening is configured to engage with the first connection portion such that the filter portion is enclosed within the housing.

12. An inline filter apparatus as claimed in claim 2, wherein the first connection portion is integral with a frame of the filter portion.

13. A coolant system for a fuel cell for powering a vehicle, the coolant system comprising the inline filter apparatus of claim 1.
